(19) United States
(12) Patent Application Publication
(10) Pub. No.: US 2010/0159808 A1
(43) Pub. Date: Jun. 24, 2010

(54) METHOD OF GLASS SURFACE FINE PROCESSING

(75) Inventors: Noriaki Shimodaira, Tokyo (JP); Mitsuru Horie, Tokyo (JP); Masabumi Ito, Ayutthaya (TH)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY LIMITED, Chiyoda-ku (JP)

(21) Appl. No.: 12/640,419

(22) Filed: Dec. 17, 2009

(30) Foreign Application Priority Data
Dec. 19, 2008 (JP) 2008-323665
Aug. 27, 2009 (JP) 2009-196971

(51) Int. Cl. C03C 15/00; B24B 1/00

(52) U.S. Cl. 451/36; 216/41

(57) ABSTRACT

The present invention relates to a method of glass surface fine processing for forming a convex portion on a surface of a glass containing alkali-metal oxides, the method including: a step of coating a surface of a first region adjacent to a surface of a second region which is to be a convex portion, with a protective layer; a step of removing alkali ions from the surface of the second region; a step of removing the protective layer from the surface of the first region; and a step of polishing the surface of the second region from which the alkali ions have been removed and the surface of the first region from which the protective layer has been removed.

### FIELD OF THE INVENTION

The present invention relates to a method of fine processing for forming concave portions and convex portions on a glass surface. More particularly, the invention relates to a method of glass surface fine processing in which not only micrometer-order but also nanometer-order fine processing can be conducted.

### BACKGROUND OF THE INVENTION

Glasses are chemically stable, have a low thermal expansion coefficient, and have excellent physical or chemical properties. Glasses are hence suitable for use as materials for chemical reaction chips, optical parts, and electronic parts. However, since glasses, on one hand, are brittle materials, it is difficult to conduct mirror finishing free from cracking and chipping by mechanical removal processing such as grinding and cutting. For conducting the mirror finishing of a glass, it is necessary to reduce processing rate and a high level of processing technique is required. It is therefore difficult to efficiently conduct mechanical mirror finishing.

JP-A-2005-298312 discloses a processing technique for realizing micrometer-order processing. In this technique, the surface of a glass which has undergone an ion-exchange treatment in which the glass was immersed in a molten salt such as KNO₃ for several hours to exchange Na⁺ ions present near the glass surface for K⁺ ions (so-called chemical strengthening treatment) is ground to thereby process the surface.

### SUMMARY OF THE INVENTION

However, the technique disclosed in JP-A-2005-298312 has a problem that since the glass to be processed has undergone chemical strengthening, this glass is apt to develop lateral cracks (delayed cracks) when processed by grinding (polishing). This technique is hence unsuitable for nanometer-order processing even through not problematic in micrometer-order processing.

Furthermore, since the ion exchange is a treatment in which a glass is immersed in a high-temperature molten salt, the processing technique disclosed in JP-A-2005-298312 necessitates the application of a mask which withstands the high temperature. The technique hence has a problem that such a treatment is troublesome.

Accordingly, an object of the invention is to provide a method of glass surface fine processing in which not only micrometer-order fine processing but also nanometer-order fine processing can be easily conducted.

Namely, the present invention is based on such findings and is relates to the following items (1) to (6).

(1) A method of glass surface fine processing for forming a convex portion on a surface of a glass containing alkali-metal oxides, the method comprising:

a step of coating a surface of a first region adjacent to a surface of a second region which is to be the convex portion, with a protective layer;

a step of removing alkali ions from the surface of the second region;

a step of removing the protective layer from the surface of the first region; and

a step of polishing the surface of the second region from which the alkali ions have been removed and the surface of the first region from which the protective layer has been removed.

(2) The method of glass surface fine processing according to (1), wherein the step of removing alkali ions from the surface of the second region comprises exposing the surface of the second region to an acidic liquid.

(3) The method of glass surface fine processing according to (2), wherein the acidic liquid has a pH of 5 or lower.

(4) The method of glass surface fine processing according to any one of (1) to (3), wherein the glass is a doughnut-shaped glass substrate for magnetic disk.

(5) The method of glass surface fine processing according to any one of (1) to (3), wherein the glass is a slide glass.

(6) A method of glass surface fine processing for forming a convex portion on a surface of a glass containing alkali-metal oxides,

the method comprising:

a step of coating surfaces of a first region and a third region which are adjacent to a surface of a second region which is to be a convex portion, with a protective layer;

a step of removing alkali ions from the surface of the second region;

a step of removing the protective layer from the surfaces of the first region and the third region; and

a step of polishing the surface of the second region from which the alkali ions have been removed and the surfaces of the first region and the third region from which the protective layer has been removed.

According to the invention, glass surface fine processing not only of the micrometer order but also of the nanometer order is possible, and the occurrence of cracks and lateral cracks can be diminished.

### BRIEF DESCRIPTION OF THE DRAWINGS

FIG. 1 is a flow chart showing the method of glass surface fine processing of the invention.

FIG. 2 is a schematic view of an example of glass surfaces, the view illustrating a second region to be a convex portion.

FIGS. 3(A) to 3(E) are schematic views illustrating a section obtained by cutting along the line III-III of FIG. 2, the views showing the glass constitution obtained after the respective steps shown in FIG. 1.

FIG. 4 is a schematic view of another example of glass surfaces, the view illustrating a second region to be a convex portion.

FIGS. 5(A) to 5(E) are schematic views illustrating a section obtained by cutting along the line V-V of FIG. 4, the views showing the glass constitution obtained after the respective steps shown in FIG. 1.

FIG. 6 is a perspective view illustrating the constitution of a slide glass produced by the method of glass surface fine processing of the invention.

FIG. 7 is a sectional view showing a section obtained by cutting the slide glass of FIG. 6 along the line A-A.

FIG. 8 is an enlarged schematic view of the part of FIG. 7 surrounded with the broken line, the view showing the state of surface ions.

FIG. 9 is a perspective view illustrating the constitution of a glass substrate for magnetic disk produced by the method of glass surface fine processing of the invention.

FIG. 10 is an enlarged schematic view of a section obtained by cutting the glass substrate for magnetic disk of FIG. 9 along the line B-B, the view showing the state of surface ions.

FIG. 11 is a graph showing the relationship between leaching depth and each of immersion time for glass A and the pH of an acidic liquid.

FIG. 12 is a graph showing the relationship between the pH of an acidic liquid and leaching depth in each of glasses A to D.

### DESCRIPTION OF REFERENCE NUMERALS

100 Slide glass
210 and 510 Convex portion
220 and 520 Concave portion
400 Glass for magnetic disk
711 First region
712 Second region
713 Third region

### DETAILED DESCRIPTION OF THE INVENTION

The method of glass surface fine processing of the invention will be explained below by reference to the drawings. However, the invention should not be construed as being limited to the drawings.

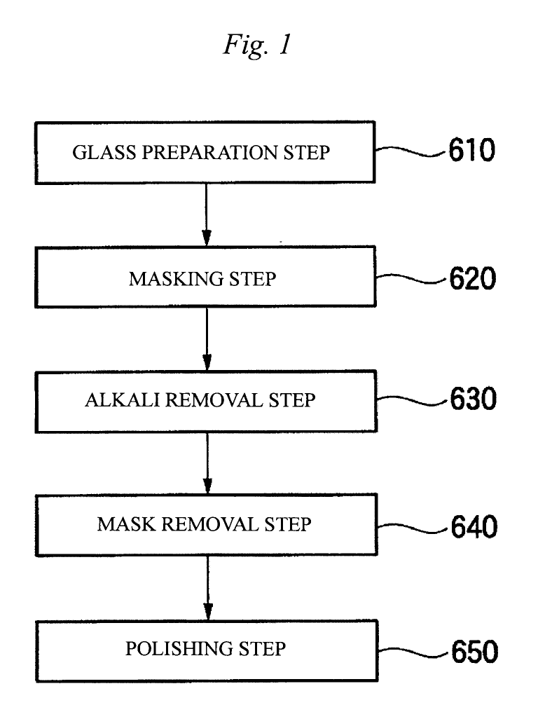

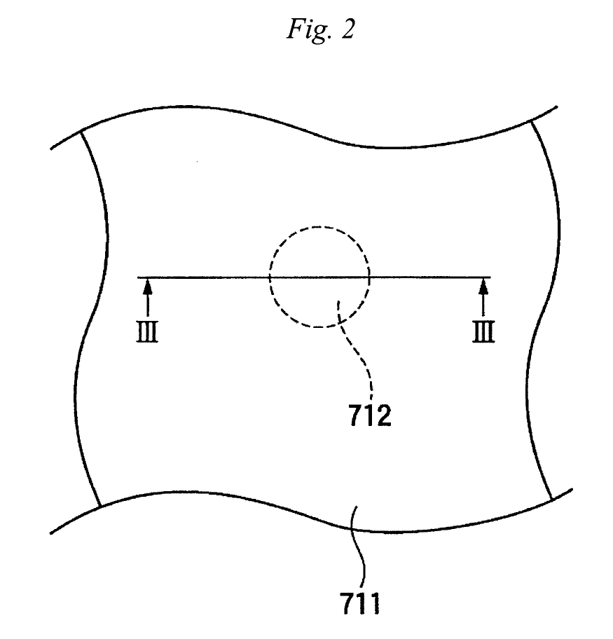

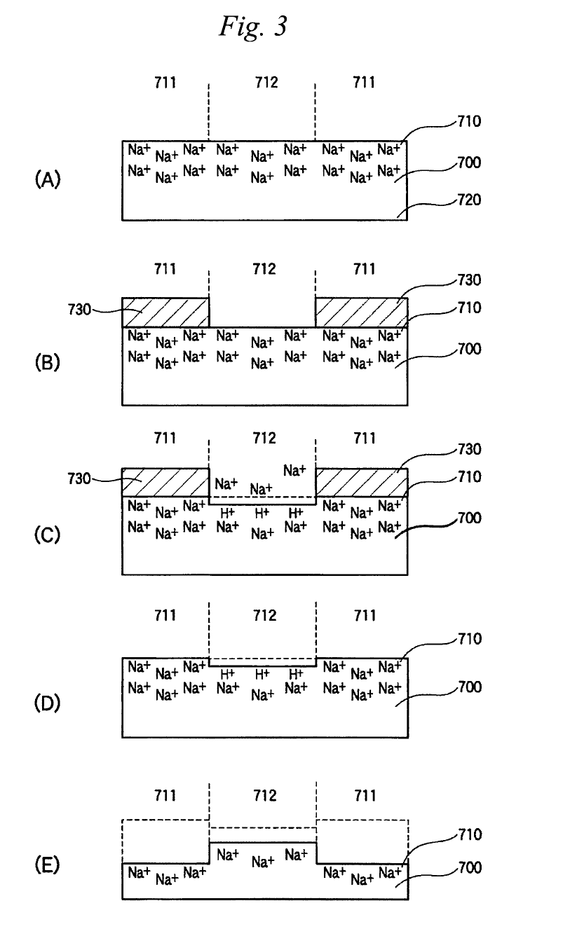

FIG. 1 is a flow chart showing the method of glass surface fine processing of the invention. FIG. 2 is a schematic view of an example of glass surfaces, the view illustrating a second region to be a convex portion. FIGS. 3(A) to 3(E) are schematic views illustrating a section obtained by cutting along the lien III-III of FIG. 2, the views showing the glass constitution obtained after the respective steps shown in FIG. 1. First, the embodiment shown in FIG. 2, in which a convex portion is formed in a second region 712 surrounded by a first region 711, is used to explain the method of glass surface fine processing of the invention.

In the method of glass surface fine processing of the invention, a glass such as a thin platy slide glass or a doughnut-shaped glass substrate for magnetic disk is prepared first (step 610). The glass 700 has a front surface 710 and a back surface 720 as shown in FIG. 3(A), and contains at least one of alkali-metal oxides such as sodium oxide, lithium oxide, and potassium oxide. The front surface 710 of the glass 700 has a first region 711 and a second region 712 adjacent to the first region 711. As shown in FIG. 3(A), alkali ions are present around the front surface of the glass 700. Although Na⁺ ions are shown as the alkali ions in FIG. 3(A), it is a matter of course that the alkali ions are not construed as being limited to Na⁺ ions. Furthermore, in FIG. 3, Na⁺ ions are shown as if they are present in linear arrangement around the surface, for the purpose of an easy understanding of the presence of alkali ions. However, it is a matter of course that the number and arrangement of alkali ions should not be construed as being limited thereto.

Subsequently, as shown in FIG. 3(B), a resist 730 having a desired pattern is formed on the front surface 710 of the glass 700 by photolithography (hereinafter referred to as masking step; step 620). The masking step includes a coating step, pre-baking step, exposure step, development step, and post-baking step. A detailed explanation is as follows. A resist fluid is applied to the whole front surface 710 of the glass 700 with a spin coater or by spraying (coating step). Subsequently, the resist-coated glass is heated to solidify the resist (pre-baking step). The resist is then irradiated with light (exposure step). In the case of a positive resist, the area which has been exposed to light is dissolved away. In this case, that part of the resist which overlies the front surface 710 of the second region 712, which is desired to be subjected to the removal of alkali ions (hereinafter referred to as alkali removal treatment), is exposed to light. On the other hand, in the case of a negative resist, the area which has been exposed to light remains. Consequently, that part of the resist which overlies the front surface 710 of the first region 711, which is not desired to be subjected to the alkali removal treatment, is exposed to light in this case. Subsequently, the glass 700 which has undergone the exposure is immersed in a developing solution to remove the unnecessary part of the resist (development step). The glass 700 is then heated (post-baking step) in order to remove the rinse used in the development step. As a result, a resist 730 as a protective layer is formed on the front surface 710 of the first resin 711, which is not desired to be subjected to the alkali removal treatment, as shown in FIG. 3(B).

Techniques for the step of forming a mask on the glass substrate are not limited to photolithography. Use may also be made of nanoimprinting or an easier technique in which a tape having excellent heat or chemical resistance, such as the so-called Kapton tape, is applied to part of the glass surface.

Subsequently, an alkali removal treatment is conducted in which alkali ions are removed from the front surface 710 side of the glass 700 as shown in FIG. 3(C) (step 630). Examples of techniques for the alkali removal treatment include immersion in hot water and exposure to an acidic aqueous solution (e.g., sulfuric acid, hydrochloric acid, oxalic acid, maleic acid, phosphoric acid, citric acid, a mixture of hydrofluoric acid and sulfuric, hydrochloric, or oxalic acid, or a mixture of hydrochloric acid and nitric acid) or to an acidic vapor (e.g., hydrogen sulfide or sulfurous acid gas) (leaching). The alkali removal treatment can be conducted: by immersing the glass 700 in hot water having a temperature of 60-99° C. for a period of about from 20 minutes to 20 hours; by immersing the glass 700 in an acidic aqueous solution having a pH of 7 or lower and a temperature of from ordinary temperature to 99° C. for a period of about from 10 seconds to 1 hour; or by exposing the glass 700 to a high-temperature high-humidity atmosphere having a humidity of 60-90% RH and a temperature of 60-200° C. for a period of from 1 hour to 10 days. In this alkali removal treatment, alkali ions (Na⁺ ions in this embodiment) present near the front surface of the glass 700 diffuse away therefrom and protons H⁺ come in instead. Since the H⁺ ion has a far smaller ionic radius than the Na⁺ ion, a compressive stress (tensile stress) such as that caused by chemical strengthening treatments does not generate in the front surface 710 of the glass 700. In chemical strengthening treatments, ions larger than the ions which have diffused away generally come in to thereby strengthen the glass surface. In contrast, in the alkali removal treatment, ions smaller than the ions which have diffused away come in to thereby render the glass surface brittle. Incidentally, the alkali removal treatment not only causes alkali ions present near the glass surface to diffuse away therefrom but also erodes the surface. Consequently, the region which has undergone the alkali removal treatment and the region which has not undergone the alkali removal treatment come to differ in glass thickness as measured from the back surface of the glass. Therefore, the second region 712 which has undergone the alkali removal treatment has a smaller glass thickness, in terms of glass thickness measured from the back surface of the glass, than the first region 711 which has not undergone the alkali removal treatment.

Incidentally, the term “alkali removal treatment” does not exclude a treatment in which alkaline earth metal ions also are removed.

Subsequently, the resist 730 overlying the front surface 710 of the glass 700 is removed with a solvent (hereinafter referred to as mask removal step; step 640). As shown in FIG. 3(D), alkali ions remain around the front surface of the first region 711 of the glass 700, which has been overlaid by the resist 730.

The front surface 710 of the glass 700 from which the resist 730 has been removed is then polished using a polishing machine (hereinafter referred to as polishing step; step 650).

Although the polishing step described above may consist of one polishing step, it may include two polishing steps (first polishing step and second polishing step). The polishing step including two polishing steps is explained below.

The first polishing step is conducted using a polyurethane foam as a polishing pad. Polishing conditions include use of a polishing slurry including cerium oxide and RO water. The glass substrate which has undergone the first polishing step is immersed successively in cleaning baths of a neutral detergent, pure water, IPA (isopropyl alcohol), and IPA (vapor drying) respectively to conduct ultrasonic cleaning and drying.

Subsequently, the polisher of the same polishing machine as that used in the first polishing step is replaced with a flexible polishing pad (polyurethane foam), and this polishing machine is used to conduct the second polishing step as the step of mirror-polishing the main surface.

The second polishing step is conducted for the purpose of polishing the flat main surface obtained in the first polishing step to remove cracks without fail while maintaining the flatness of the main surface and to obtain a mirror surface having a surface roughness reduced to, e.g., about 0.4 to 0.1 nm in terms of arithmetic mean roughness (Ra). As a polishing slurry, a polishing slurry including colloidal-silica abrasive grains (average particle diameter, 80 nm or smaller) and RO water is used. This polishing may be conducted under a load of 100 g/cm² for a polishing period of 5 minutes.

The glass substrate which has undergone the second polishing step is immersed successively in cleaning baths of a neutral detergent, pure water, IPA (isopropyl alcohol), and IPA (vapor drying) respectively to conduct ultrasonic cleaning and drying. In this polishing step, the glass of the first region 711, which has not undergone the alkali removal treatment, is polished more deeply than the glass of the second region 712, which has undergone the alkali removal treatment. As a result, the relationship concerning glass thickness observed after the alkali removal treatment is reversed. Namely, the second region 712, which has undergone the alkali removal treatment, comes to have a larger glass thickness, in terms of glass thickness as measured from the back surface of the glass, than the first region 711, which has not undergone the alkali removal treatment, as shown in FIG. 3(E).

In the glass 700 which has undergone the second polishing step, the alkali ion concentration of an area near the front glass surface of the second region 712, which has undergone the alkali removal treatment, is the same as the alkali metal ion concentration of an area near the front glass surface of the first region 711, which has not undergone the alkali removal treatment. The concentration of alkali metal ions can be determined by examining the glass surface by X-ray photoelectron spectroscopy (XPS; electron spectroscopy for chemical analysis (ESCA)). The concentration of alkali metal ions can also be determined from a line profile obtained by examining a section of the glass with an electron beam microanalyzer (electron probe microanalyzer; EPMA).

In the method of glass surface fine processing of the invention, the front surface of the region which is subjected to the alkali removal treatment (second region 712) is eroded and becomes brittle due to the alkali removal treatment, and this region 712 comes to have a smaller thickness than the region which has not undergone the alkali removal treatment (first region 711). However, this thickness relationship is reversed in the subsequent polishing; the region which has not undergone the alkali removal treatment (first region 711) comes to have a smaller thickness than the region which has undergone the alkali removal treatment (second region 712) through the polishing. This phenomenon is attributable to a finding made by the present inventors.

Although the mechanism of the phenomenon has not been elucidated, the following is presumed. The region which has undergone the alkali removal treatment (second region 712) is in the state that the front surface thereof has been eroded and become brittle due to the alkali removal treatment, and this region shows elastic behavior in the subsequent polishing, resulting in a difference in polishing rate. Consequently, the region which has not undergone the alkali removal treatment (first region 711) is polished in a larger amount with the slurry. It has been ascertained that the difference in thickness obtained through the reversal is from several times to tens of times the glass thickness difference resulting from the alkali removal treatment.

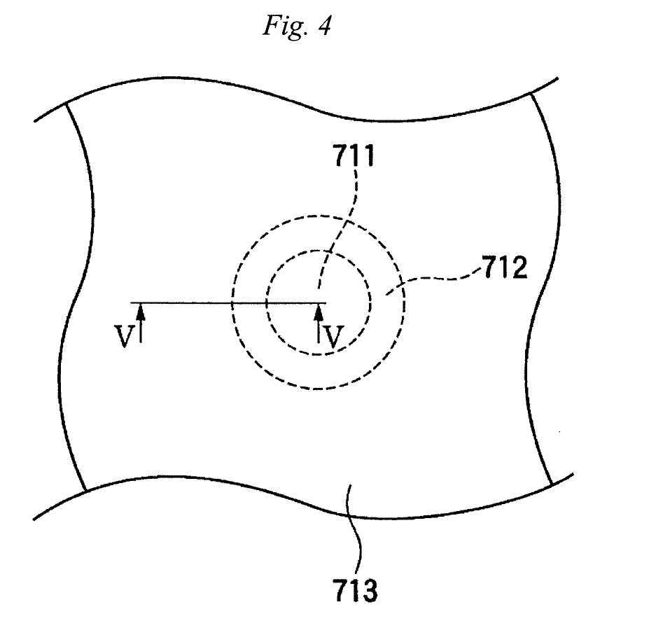

In the embodiment described above, a convex portion was formed in the second region 712 surrounded by the first region 711. However, the method of the invention is applicable also to the case where a convex portion is formed in a second region 712 interposed between and adjacent to a first region 711 and a third region 713, as shown in FIG. 4.

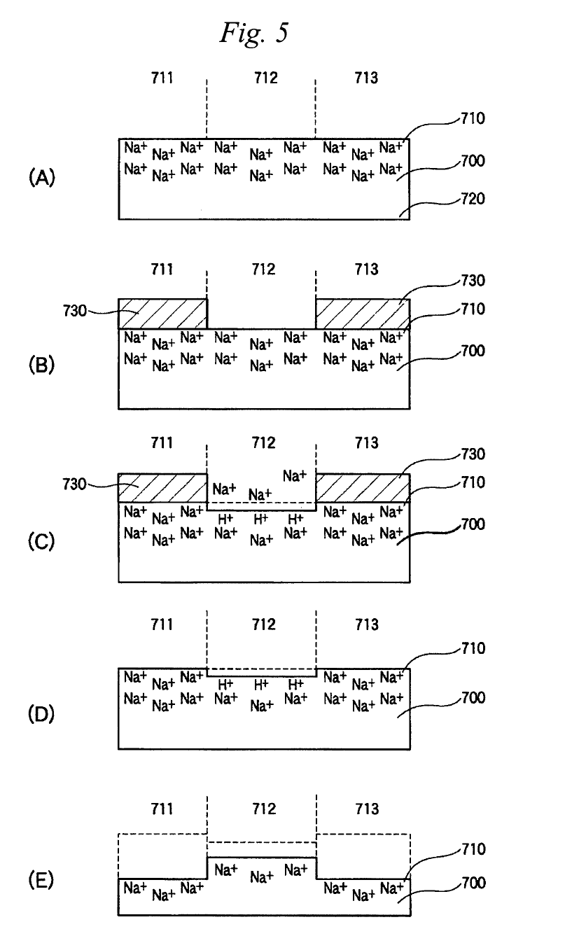

In this case, a resist 730 is formed on the front surface 710 of the first region 711 and third region 713, which are not desired to be subjected to an alkali removal treatment (see FIG. 5(B)). This glass 700 is subjected to an alkali removal treatment to remove alkali ions from the front surface 710 side of the glass 700 (see FIG. 5(C)). Subsequently, the resist 730 overlying the front surface 710 of the glass 700 is removed with a solvent (see FIG. 5(D)). Thereafter, the front surface 710 of the glass 700 from which the resist 730 has been removed is polished. As a result, the second region 712, which has undergone the alkali removal treatment, comes to have a larger glass thickness than the first region 711 and third region 713, which have not undergone the alkali removal treatment. A convex portion is thus formed in the second region 712 (see FIG. 5(E)). In this case also, the following phenomenon occurs as in the embodiment described above. The front surface of the region which is subjected to the alkali removal treatment (second region 712) is eroded and becomes brittle due to the alkali removal treatment, and this region 712 comes to have a smaller thickness than the regions which have not undergone the alkali removal treatment (first region 711 and third region 713). However, this thickness relationship is reversed in the subsequent polishing; the regions which have not undergone the alkali removal treatment (first region 711 and third region 713) come to have a smaller thickness than the region which has undergone the alkali removal treatment (second region 712) through the polishing.

Glass

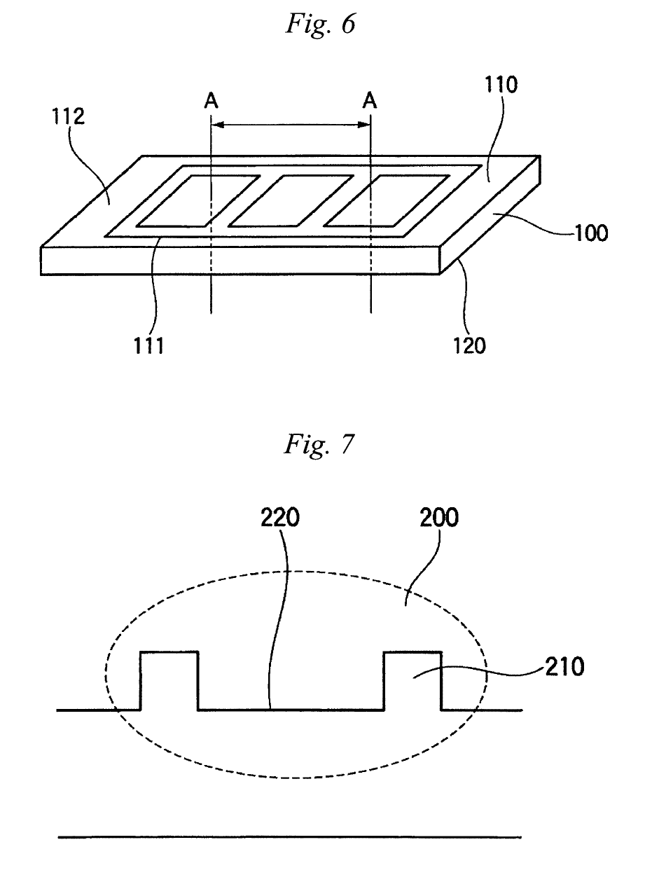

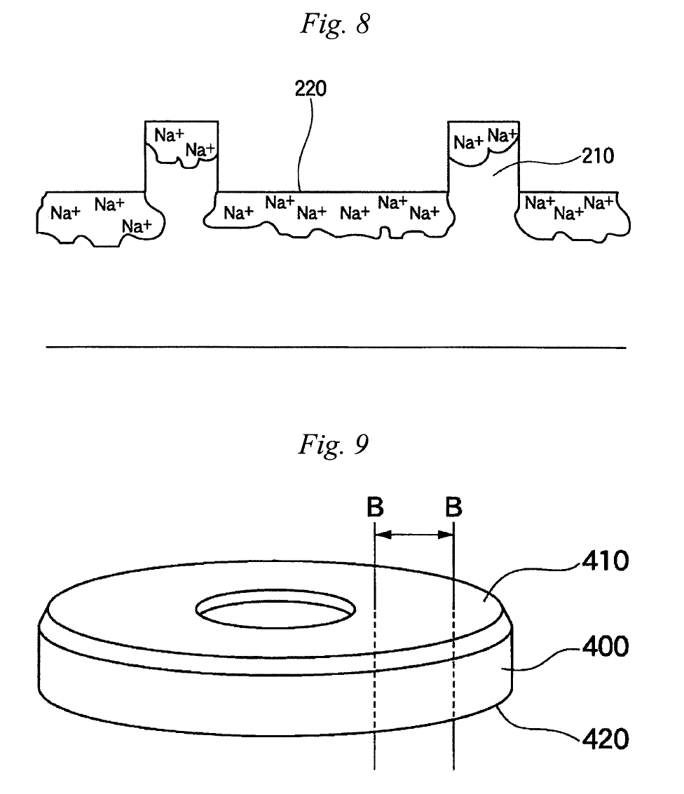

FIG. 6 is a perspective view illustrating the constitution of a slide glass produced by the method of glass surface fine processing of the invention. FIG. 7 is a sectional view showing a section obtained by cutting the slide glass of FIG. 6 along the line A-A. FIG. 8 is an enlarged schematic view of the part 200 of FIG. 7 surrounded with the broken line, the view showing the state of surface ions.

Examples of the slide glass include aluminosilicate glass, aluminoborosilicate glass, soda-lime glass, and borosilicate glass. Especially for use in biotechnology involving DNAs or the like, borosilicate glass is preferred. Borosilicate glass may contain glass components which, for example, include 90-95% of SiO₂, 6-7% of B₂O₃, 0.3-1% of Na₂O, and 0.01-1% of Al₂O₃ in terms of % by mass. In the case where a slide glass for use in synthesizing a DNA is produced, it is preferred to regulate the content of Al₂O₃ so as not to exceed 0.1% by mass, because the glass increases in adsorbed-water amount in proportion to Al₂O₃ content.

The slide glass has a visible light transmittance of preferably 90% or higher. The refractive index of the slide glass is preferably 1.51-1.53 when measured with the e-line (546.1 nm) as provided for in JIS R3703.

As shown in FIG. 6, the slide glass 100 has a front surface 110 and a back surface 120. The front surface 110 of the slide glass 100 has a concave-convex forming region 111 and a peripheral region 112. As shown in FIG. 7, the concave-convex forming region 111 has convex portions 210 and concave portions 220 which have been formed by the method of glass surface fine processing described above. In this slide glass 100, the difference in level between the convex portions 210 and the concave portions 220 is preferably several micrometers. In the slide glass 100, the amount of the alkali component in an area near the front surface of the convex portions 210 is almost the same as the amount of the alkali component in an area near the front surface of the concave portions 220 as shown in FIG. 8. The concentration of alkali metal ions can be determined by X-ray photoelectron spectroscopy or with an electron ray microanalyzer as stated above. Incidentally, the concave portions 220 each are intended to hold a sample to be examined.

Although the slide glass 100 shown in FIG. 6 has three regions (concave portions) for holding a sample, this figure should not be construed as limiting the number of such concave portions. It is a matter of course that the number of such concave portions is not limited so long as it is 1 or larger. It is preferred that rectangular concave portions 220 should be formed in a lattice arrangement at a pitch of, for example, 100 μm. Furthermore, although Na⁺ ions only are shown in the schematic view of FIG. 8, the alkali ions should not be construed as being limited to Na⁺ ions. It is a matter of course that other kinds of alkali ions (e.g., Li⁺ and K⁺ ions) are possible. In addition, although the schematic view of FIG. 8 shows that only one to two Na⁺ ions are present in the surface of each convex portion, it is a matter of course that the number of alkali ions is not limited.

The slide glass 100 produced by the method of glass surface fine processing of the invention has an advantage that after the formation of concave portions and convex portions by the method, the slide glass can be easily cut into pieces of the same size suitable for use, regardless of the size, because the glass has undergone no chemical strengthening treatment. In contrast, in the conventional technique for glass surface fine processing, there has been a possibility that cutting of the slide glass after the formation of concave portions and convex portions might cause breakage because the fine processing technique includes a chemical strengthening treatment. It has hence been necessary that a glass which has been cut beforehand into a size suitable for use should be subjected to the formation of concave portions and convex portions.

Glass Substrate for Magnetic Disk

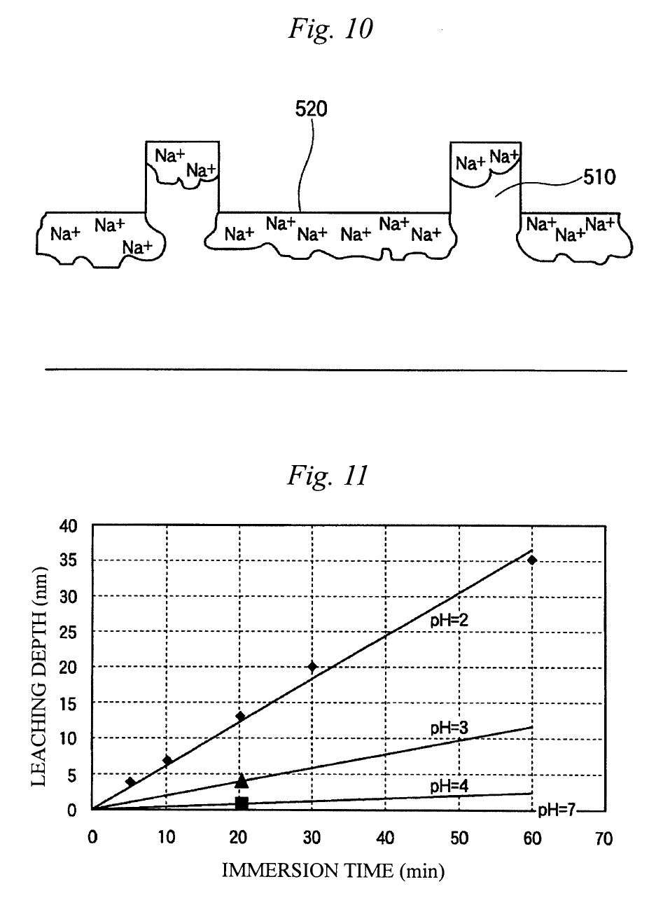

FIG. 9 is a perspective view illustrating the constitution of a glass substrate for magnetic disk produced by the method of glass surface fine processing of the invention. FIG. 10 is an enlarged schematic view of a section obtained by cutting the glass substrate for magnetic disk of FIG. 9 along the line B-B, the view showing the state of surface ions. The glass substrate for magnetic disk has a doughnut shape which has in a central region a through-hole extending from the front surface to the back surface.

Examples of the glass substrate for magnetic disk include lithium silicate glass, aluminosilicate glass, aluminolithium silicate glass, aluminoborosilicate glass, soda-lime glass, and borosilicate glass. However, aluminosilicate glass is preferred. Furthermore, amorphous glasses and crystallized glasses can also be used. In the case where a soft-magnetic layer which is amorphous is to be formed on the glass, this glass preferably is an amorphous glass. For example, one aluminosilicate glass contains glass components including 57-74% of SiO₂, 0-2.8% of ZnO₂, 3-15% of Al₂O₃, 7-16% of Li₂O, and 4-14% of Na₂O in terms of % by mole. Another aluminosilicate glass contains glass components including 50-65% of SiO₂, 5-15% of Al₂O₃, 2-7% of Na₂O, 4-9% of K₂O, 0.5-5% of MgO, 2-8% of CaO, and 1-6% of ZrO₂ in terms of % by mass. Glass components for obtaining a high Young's modulus (100 GPa or higher) include 45-65% of SiO₂, 0-15% of Al₂O₃, 4-20% of Li₂₀, 1-8% of Na₂O, 0-21% of CaO, 0-22% of MgO, 0-16% of Y₂O₃, 1-15% of TiO₂, and 0-10% of ZrO₂ in terms of % by mole.

As shown in FIG. 9, the glass 400 for magnetic disk has a front surface 410 and a back surface 420. The front surface 410 of the glass 400 for magnetic disk has convex portions 510 and concave portions 520 which have been formed by the method of glass surface fine processing described above. The difference in level between the convex portions 510 and the concave portions 520 is preferably 10-100 nm. The convex portions 510 are in the form of circles which are continuous in the circumferential direction and have been concentrically formed at a radial pitch of, for example, 100 nm.

In the glass 400 for magnetic disk, the amount of the alkali component in an area near the front surface of the convex portions 510 is almost the same as the amount of the alkali component in an area near the front surface of the concave portions 520 as shown in FIG. 10. The arithmetic mean roughness Ra of the front surface of the convex portions 510 is almost the same as the arithmetic mean roughness Ra of the front surface of the concave portions 520. The concentration of alkali metal ions can be determined by X-ray photoelectron spectroscopy or with an electron ray microanalyzer as stated above.

In producing a magnetic disk, a magnetic recording layer is formed on the glass obtained through the steps described above. As this magnetic recording layer, use can be made of, for example, one constituted of or containing a cobalt (Co)-based ferromagnetic material. It is especially preferred to form a magnetic recording layer constituted of or containing a cobalt-platinum (Co—Pt) ferromagnetic material or a cobalt-chromium (Co—Cr) ferromagnetic material, which give high coercive force. As a technique for forming such a magnetic recording layer, DC magnetron sputtering can be used. It is preferred to suitably interpose a prime coat layer or the like between the glass substrate and the magnetic recording layer. As the material of the prime coat layer or the like, use can be made of an Fe—Ni alloy, Fe—Nb alloy, Fe—Co alloy, Ru-based alloy, or the like. A protective layer for protecting the magnetic disk against magnetic-head impacts can be formed on the magnetic recording layer. It is preferred that this protective layer should be a rigid protective hydrocarbon layer. Furthermore, a lubricating layer constituted of a PFPE (perfluoropolyether) compound may be formed on the protective layer, whereby interference between the magnetic head and the magnetic disk can be mitigated. This lubricating layer can be formed, for example, through coating fluid application by dipping.

According to the glass 400 for magnetic disk produced by the method of glass surface fine processing of the invention, discrete tracks can be formed in the magnetic disk. Interference between adjacent recording tracks can hence be prevented to attain an increase in recording density.

### EXAMPLES

Examples of the method of glass surface fine processing of the invention are explained below.

### Example 1

First, a glass which was aluminolithium silicate glass was prepared. This glass was polished with a ceria slurry or colloidal-silica slurry so as to result in an average surface roughness lower than 10 nm.

Subsequently, a given region was masked with a Kapton tape.

At room temperature, this glass was then immersed for 30 minutes in an aqueous nitric acid solution regulated so as to have a pH of 2. Thus, the region not covered with the mask was subjected to an alkali removal treatment. In the region not covered with the mask (the region subjected to the alkali removal treatment), alkali ions diffused away from an area near the glass surface and this surface was slightly eroded. As a result, the region which was subjected to the alkali removal treatment came to have a smaller glass thickness, in terms of the glass thickness measured from the back surface of the glass, than the region which had been masked (the region which had not undergone the alkali removal treatment). The glass thickness in the region which had undergone the alkali removal treatment differed by 20 nm from the glass thickness in the region which had not undergone the alkali removal treatment.

The Kapton tape was then stripped off.

Subsequently, a colloidal-silica slurry was used to polish the glass for 3 minutes. As a result, the glass located in the region which had not undergone the alkali removal treatment was polished in a larger amount than the glass located in the region which had undergone the alkali removal treatment. As a result, the relationship concerning glass thickness observed after the alkali removal treatment was reversed by the polishing. Namely, the region which had not undergone the alkali removal treatment came to have a smaller glass thickness than the region which had undergone the alkali removal treatment. The glass thickness in the region which had not undergone the alkali removal treatment differed by about 100 nm from the glass thickness in the region which had undergone the alkali removal treatment. It was ascertained that the glass composition of an area near the glass surface in the region which had not undergone the alkali removal treatment was the same as the glass composition of an area near the glass surface in the region which had undergone the alkali removal treatment. Namely, it was found that after the polishing, the alkali ion concentration of the area near the glass surface in the region which had not undergone the alkali removal treatment was the same as the alkali ion concentration of the area near the glass surface in the region which had undergone the alkali removal treatment.

### Example 2

The same glass as in Example 1 was prepared, and a region in the glass was covered with a Kapton tape in the same manner as in Example 1.

Subsequently, this glass was immersed for 30 minutes in an aqueous nitric acid solution regulated so as to have a pH of 2. This immersion was conducted at 40° C. as different from that in Example 1. Thus, the region not covered with the mask was subjected to an alkali removal treatment. As in Example 1, in the region which was subjected to the alkali removal treatment, alkali ions diffused away from an area near the glass surface and this surface was slightly eroded. As a result, the glass thickness in the region which had undergone the alkali removal treatment differed by 30 nm from the glass thickness in the region which had not undergone the alkali removal treatment.

The Kapton tape was then stripped off as in Example 1.

Subsequently, a colloidal-silica slurry was used to polish the glass as in Example 1. This polishing was conducted for a period of 30 minutes, as different from the polishing in Example 1. As a result, the glass located in the region which had not undergone the alkali removal treatment was polished in a larger amount than the glass located in the region which had undergone the alkali removal treatment. As a result, the relationship concerning glass thickness observed after the alkali removal treatment was reversed by the polishing. Namely, the region which had not undergone the alkali removal treatment came to have a smaller glass thickness than the region which had undergone the alkali removal treatment. The glass thickness in the region which had not undergone the alkali removal treatment differed by about 600 nm from the glass thickness in the region which had undergone the alkali removal treatment. It was ascertained that the glass composition of an area near the glass surface in the region which had not undergone the alkali removal treatment was the same as the glass composition of an area near the glass surface in the region which had undergone the alkali removal treatment. Namely, it was found that after the polishing, the alkali ion concentration of the area near the glass surface in the region which had not undergone the alkali removal treatment was the same as the alkali ion concentration of the area near the glass surface in the region which had undergone the alkali removal treatment.

### Example 3

Among alkali removal treatments, especially the leaching in which a glass was immersed in an acidic liquid was examined for relationship with glass composition, immersion time, temperature, and pH.

First, four glasses having the respective compositions shown in Table 1 were prepared. In Table 1, the compositions are shown in terms of % by mole.

TABLE 1

| Glass | SiO₂ | Al₂O₃ | MgO | CaO | SrO | BaO | TiO₂ | ZrO₂ | Li₂O | Na₂O | K₂O |
|---|---|---|---|---|---|---|---|---|---|---|---|
| A | 61.9 | 13.0 | 3.0 | — | — | — | 1.0 | 0.6 | 10.7 | 6.8 | 3.0 |
| B | 64.5 | 12.0 | — | — | — | — | — | 1.8 | 12.8 | 5.5 | 3.4 |
| C | 66.5 | 4.7 | 3.4 | 6.2 | 4.7 | 3.6 | — | 1.7 | — | 4.8 | 4.4 |
| D | 66.4 | 5.0 | 12.1 | — | — | — | 3.7 | — | — | 5.0 | 7.7 |

Subsequently, glass A was immersed at room temperature in nitric acid with a pH of 2.0 for each of 5 minutes, 10 minutes, 20 minutes, 30 minutes, and 60 minutes. Thereafter, the depth of the concave portion formed in the glass A (hereinafter referred to as leaching depth) was measured. Furthermore, glass A was immersed for 20 minutes in each of nitric acids respectively having pH values of 3.0, 4.0, and 7.0, and then examined for leaching depth. The results of the measurements are shown in FIG. 11.

The results given in FIG. 11 show the following. At pH values not lower than 7.0, glass A was unable to be treated by leaching within 60 minutes. Furthermore, the longer the immersion time and the lower the pH, the larger the leaching depth. It was hence found that use of an acidic liquid with a pH lower than 7.0 in the leaching is preferred and that a glass having a desired leaching depth can be obtained by regulating immersion time according to the pH of the acidic liquid. In particular, at pH values not higher than 5, leaching can be conducted without fail. The leaching depth obtained at a pH of 2 was at least 10 times the leaching depth obtained at a pH of 4, and was nearly 3 times the leaching depth obtained at a pH of 3. It was thus ascertained that a pH of 2 or lower is more preferred. The same examination was conducted, except that the temperature of the nitric acids was elevated from room temperature to 70° C. As a result, the resultant dependence of leaching depth on time was found to be about ten times the dependence thereof as measured at room temperature. It was thus found that the higher the temperature of the acidic liquid, the larger the leaching depth.

Furthermore, glass A was used to conduct the same examination, except that each of hydrochloric acid, sulfuric acid, and maleic acid was used in place of nitric acid. As a result, almost the same behavior was exhibited with respect to the dependence of leaching depth on time. On the other hand, the same examination was conducted, except that each of phosphoric acid, citric acid, and oxalic acid was used in place of nitric acid. As a result, the resultant dependence of leaching depth on time was about ten times the dependence thereof as measured with nitric acid. It was thus found that leaching depends not only on the pH and temperature of the acidic liquid but also on the kind of the acidic liquid.

Subsequently, glasses B to D also were subjected to an examination for leaching depth under the conditions shown in Table 2.

TABLE 2

| Glass | Acidic liquid | Temperature | pH |
|---|---|---|---|
| B | nitric acid | room temperature | 2.0 |
| C | nitric acid | room temperature | 2.0 |
| | nitric acid | room temperature | −4.8 |
| | nitric acid | 70° C. | −4.8 |
| D | nitric acid | room temperature | 2.0 |

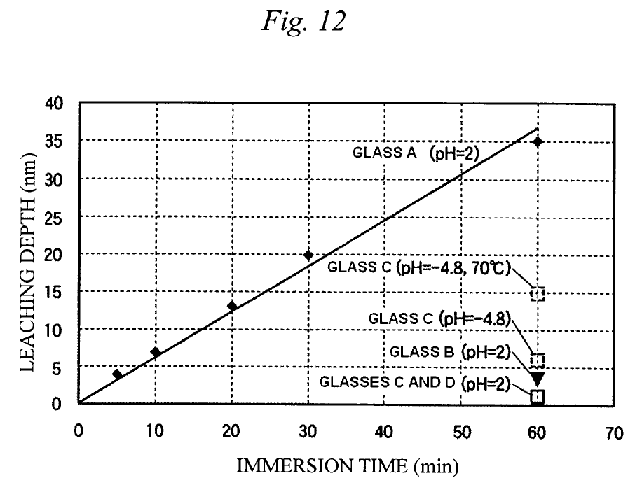

The results of the examination of glasses B to D are shown in FIG. 12 together with the results concerning glass A.

Glasses B to D are less apt to be treated by leaching as compared with glass A. However, it was ascertained that leaching depth therein can be controlled, as in glass A, by lowering the pH of the acidic liquid, elevating the temperature of the acidic liquid, or prolonging the immersion time.

As explained above, the method of glass surface fine processing of the invention produces the following effects. As shown in Examples 1 and 2, by partly conducting an alkali removal treatment and then performing polishing, the level-difference relationship between the region which has undergone the alkali removal treatment and the region which has not undergone the alkali removal treatment is reversed. Consequently, concave portions and convex portions not only of the order of micrometer but also of the order of nanometer can be formed on a glass surface while avoiding the occurrence of cracks or lateral cracks. Furthermore, as shown in Example 3, the alkali removal treatment can be conducted, for example, by leaching so as to obtain a desired leaching depth by regulating the kind, pH, and temperature of the acidic liquid and the time of immersion therein. The height of the glass concave portions or convex portions to be finally formed can be controlled by suitably regulating the time period of the subsequent polishing.

While the invention has been described in detail and with reference to specific embodiments thereof, it will be apparent to one skilled in the art that various changes and modifications can be made therein without departing from the spirit and scope thereof.

This application is based on Japanese Patent Applications (Patent Application No. 2008-323665 filed on Dec. 19, 2008 and Patent Application No. 2009-196971 filed on Aug. 27, 2009), the entirety of which is incorporated herein by way of reference.

All references cited herein are incorporated by reference herein in their entirety.

What is claimed is:

1. A method of glass surface fine processing for forming a convex portion on a surface of a glass containing alkali-metal oxides,
said method comprising:
a step of coating a surface of a first region adjacent to a surface of a second region which is to be the convex portion, with a protective layer;
a step of removing alkali ions from the surface of the second region;
a step of removing the protective layer from the surface of the first region; and
a step of polishing the surface of the second region from which the alkali ions have been removed and the surface of the first region from which the protective layer has been removed.

2. The method of glass surface fine processing according to claim 1, wherein the step of removing alkali ions from the surface of the second region comprises exposing the surface of the second region to an acidic liquid.

3. The method of glass surface fine processing according to claim 2, wherein the acidic liquid has a pH of 5 or lower.

4. The method of glass surface fine processing according to claim 1, wherein the glass is a doughnut-shaped glass substrate for magnetic disk.

5. The method of glass surface fine processing according to claim 1, wherein the glass is a slide glass.

6. A method of glass surface fine processing for forming a convex portion on a surface of a glass containing alkali-metal oxides,
said method comprising:
a step of coating surfaces of a first region and a third region which are adjacent to a surface of a second region which is to be a convex portion, with a protective layer;
a step of removing alkali ions from the surface of the second region;
a step of removing the protective layer from the surfaces of the first region and the third region; and
a step of polishing the surface of the second region from which the alkali ions have been removed and the surfaces of the first region and the third region from which the protective layer has been removed.
